(19) United States
(12) Patent Application Publication
(10) Pub. No.: US 2012/0010328 A1
(43) Pub. Date: Jan. 12, 2012

(54) CAST RESIN SYSTEM FOR ISOLATORS

(75) Inventor: Gernot Swiatkowski, Berlin (DE)

(73) Assignee: SIEMENS AKTIENGESELLSCHAFT, Muenchen (DE)

(21) Appl. No.: 13/254,864

(22) PCT Filed: Feb. 23, 2010
(86) PCT No.: PCT/EP2010/052269

§ 371 Date: Sep. 6, 2011

(30) Foreign Application Priority Data
Mar. 6, 2009 (DE) 10 2009 012 195.1

(51) Int. Cl. C08L 63/02; C08K 3/26; C08K 3/36; C08K 3/22

(52) U.S. Cl. 523/427; 525/524

(57) ABSTRACT

A casting resin for switchboards contains bisphenol F fluid epoxy resin. The properties of the casting resin can be significantly improved compared to bisphenol A-based casting resins, in particular regarding glass transition temperature and temperature shock resistance. More specifically, the glass transition temperature is advantageously increased for significantly better performance.

The present invention relates to the field of casting resin systems for switchgear.

In electrical switchgear—especially in the case of compact design—the insulating composition plays an important role.

Among other resins, what are called solid resins are used. These are usually produced by what is called an advancement process, wherein liquid resins are reacted with a suitable starting component, usually bisphenol A, and a catalyst. As a result of this process, which proceeds exothermically, systems based on solid resins evolve favorable exothermicity during curing. In addition, the systems, due to the chain extension, are more flexible than liquid resin systems.

In these resins, a high glass transition temperature is advantageous, but at the same time there are frequently also high demands on favorable mechanical properties such as low cracking propensity and high burst values.

It was thus an object of the present invention, as an alternative to the existing solutions, to provide a solid resin system for switchgear, in which an increased glass transition temperature with simultaneously good or even improved other properties is discovered.

This object is achieved by a solid resin system according to claim 1 of the present application. Accordingly, a solid resin system is proposed for insulating materials in switchgear, formed from the starting materials comprising a solid resin based on bisphenol A and a liquid resin based on bisphenol F.

It has been found that, surprisingly, in the case of use of liquid epoxy resins based on bisphenol F, some mechanical and/or electrical properties of the resin system can be greatly improved. According to the application, these include
better burst values
better thermal cycling characteristics
increased glass transition temperature.

In the context of the present invention, the term “based on X” includes and/or encompasses more particularly the fact that one starting component used—especially the main component—is the compound X. It is possible to use all other substances known in the prior art as additives.

In the context of the present invention, “bisphenol F” is understood to mean the chemical compound 4,4′-dihydroxy-diphenylmethane, which has the following structure:

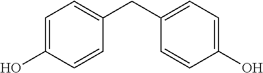

In the context of the present invention, “bisphenol A” is understood to mean the chemical compound 2,2′-bis(4-hydroxyphenyl)propane, which has the following structure:

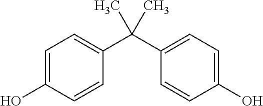

In the context of the present invention, the terms “solid resin”, “liquid resin” and “solid resin system” include and/or encompass especially an epoxy resin formed from the starting components comprising epichlorohydrin (or other suitable starting epoxide components) and bisphenols.

In the context of the present invention, the term “switchgear” includes and/or encompasses more particularly systems for low, medium and high voltage.

In the context of the present invention, the term “formed from the starting component(s)” means and/or encompasses more particularly the fact that the solid resin system is produced from this/these component(s).

In a preferred embodiment of the present compound, the solid resin system before curing has an epoxide number (DIN ISO 16945) of ≧0.2 to ≦0.55, preferably ≧0.35 to ≦0.50, more preferably ≧0.4 to ≦0.45. This has been found to be favorable in practice.

Preferably, the proportion of the liquid resin based on bisphenol F in the solid resin system (measured in weight/weight of the overall resin) is from ≧5% to ≦60%, more preferably ≧10% to ≦50%.

In a preferred embodiment of the present invention, the liquid resin based on bisphenol F has an epoxide number (DIN ISO 16945) of ≧0.4 to ≦0.63, preferably ≧0.45 to ≦0.6, more preferably ≧0.5 to ≦0.59. This has been found to be favorable in practice.

Preferably, the bisphenol F liquid resin is mixed with solid resin based on bisphenol A (mixing being ensured by melting if appropriate or by other suitable methods), before curing is effected.

In a preferred embodiment of the present compound, the solid resin based on bisphenol A has an epoxide number (DIN ISO 16945) of ≧0.2 to ≦0.3, preferably ≧0.22 to ≦0.28, more preferably ≧0.24 to ≦0.26. This has been found to be favorable in practice.

In a preferred embodiment of the present invention, the starting materials from which the solid resin system is formed comprise a hardener component.

The hardener component is preferably selected from the group comprising phthalic anhydride, tetrahydrophthalic anhydride, methylnadic anhydride, hydrogenated methylnadic anhydride, methylhexahydrophthalic anhydride, hexahydrophthalic anhydride, methyltetrahydrophthalic anhydride, and the derivatives and mixtures thereof. Especially preferred are mixtures of phthalic anhydride and tetrahydrophthalic anhydride.

In a preferred embodiment of the present invention, the starting materials from which the solid resin system is formed comprise an accelerator component.

The accelerator component is preferably selected from the group comprising tertiary amines, quaternary ammonium compounds, phosphines, phosphonium compounds, BCl₃-amine complexes, imidazoles, and the derivatives and mixtures thereof.

In a more preferred embodiment of the present invention, the accelerator component is selected from the group comprising 1-methylimidazole, 1-ethylimidiazole, 1-propylimidazole, 1-isopropylimidazole, 1,2-dimethylimidazole, 2-ethyl-4-ethylimidazole, imidazole, 1-benzyl-2-phenylimidazole, 1-vinylimidazole, 2-methylimidazole, 2-heptadecylimidazole and mixtures thereof.

In a preferred embodiment of the present invention, the starting materials from which the solid resin system is formed comprise a filler.

This filler is preferably selected from the group comprising SiO₂, dolomite, Al₂O₃, CaCO₃, TiO₂ and derivatives and mixtures thereof.

Particular preference is given to Al₂O₃, especially Al₂O₃ with a d₅₀ of ≧2 μm to ≦6 μm. This has been found to be useful in practice since the burst resistance can thus often be increased further. More preferred are ≧2.5 μm to ≦5 μm, more preferably ≧3 μm to ≦3.5 μm.

In a preferred embodiment of the present invention, the proportion of the filler in the solid resin system (in weight/weight of the overall mixture) is from 50% to ≦75%. Preference is given to ≦60% to ≦70%, more preferably ≧65% to ≦68%.

In a preferred embodiment of the present invention, the solid resin system is produced in a curing process comprising a curing step at 140° C., preferably ≧150° C., and a curing time of ≧12 h, preferably ≧14 h and most preferably ≧16 h.

In a preferred embodiment of the present invention, the solid resin system is produced by a method comprising the steps of:
a) initially charging a solid resin based on bisphenol A
b) mixing this solid resin with a liquid resin based on bisphenol F, optionally with heating or other suitable methods
c) curing the solid resin-liquid resin mixture, optionally with addition of at least one hardener component, of an accelerator component and/or of a filler, with at least one curing step at ≧140° C., preferably ≧150° C., and a curing time of ≧12 h, preferably ≧14 h and most preferably ≧16 h.

The potting is preferably effected under reduced pressure.

The present invention also relates to an insulating part comprising an insulating resin according to the present invention. The insulating part is preferably part of a GIS system.

The present invention also relates to the use of a solid resin comprising a solid resin based on bisphenol A and a liquid resin based on bisphenol F as a starting material as an insulating system for switchgear.

The aforementioned components, and those claimed and those for use in accordance with the invention which are described in the working examples, are not subject to any particular exceptional conditions in terms of their size, shape configuration, material selection and technical design, and so the selection criteria known in the field of use can be applied without restriction.

Further details, features and advantages of the subject-matter of the invention are evident from the dependent claims and from the description of the accompanying examples which follows.

### EXAMPLE I

The present invention is examined—in a purely illustrative and nonrestrictive manner—with reference to the present inventive example I.

This involved first producing a mixture of bisphenol A solid resin and bisphenol F liquid resin by mixing bisphenol A solid resin having an epoxide number of 0.26 with bisphenol F liquid resin having an epoxide number of 0.58 so as to give a resin having an epoxide number of 0.42.

Subsequently, this resin was mixed and cured with further components according to the following list:

| | rel. proportion |
|---|---|
| Component | by weight |
| resin | 100 |
| tetrahydrophthalic anhydride | 44 |
| phthalic anhydride | 22 |
| alumina (d₅₀: 3.3 μm) | 352 |
| 2-methylimidazole | 0.015 |

The resulting solid system was cured at 130° C. for 3 h, then finally at 150° C. for 16 h.

In addition, a (noninventive) comparative resin system was produced.

### Comparative Example I

In comparative example I, the bisphenol F liquid resin was replaced by bisphenol A liquid resin. The production conditions were otherwise the same.

The particular resin mixtures were used to cast test bars and insulators. In one test, firstly, the tensile strength [ISO 527-4], the Martens temperature and the burst value after thermal cycles (pressure test with water) were determined.

| | Tensile | | |
|---|---|---|---|
| Resin system | strength | Martens (° C.) | Burst value |
| Vergleichsbeispiel | 70 N/mm² | 143 | Missed |
| I | | | target value |
| Example I | 90 N/mm² | 133 | Hit target |
| | | | value |

The advantageous properties of the inventive solid resin system are thus apparent.

1-9. (canceled)

10. A solid resin system for insulating compositions in switchgear, comprising:
a solid resin based on bisphenol A; and
a liquid resin based on bisphenol F.

11. The solid resin system according to claim 10, wherein a proportion of said liquid resin based on bisphenol F in the solid resin system measured in weight/weight of an overall resin is from ≧5% to ≦60%.

12. The solid resin system according to claim 10, wherein said liquid resin based on bisphenol F has an epoxide number (DIN ISO 16945) of ≧0.4 to ≦0.63.

13. The solid resin system according to claim 10, wherein starting materials from which said solid resin is formed contain an accelerator component selected from the group consisting of tertiary amines, quaternary ammonium compounds, phosphines, phosphonium compounds, BCl₃-amine complexes, imidazoles, and derivatives and mixtures thereof.

14. The solid resin system according to claim 13, wherein said accelerator component is selected from the group consisting of 1-methylimidazole, 1-ethylimidazole, 1-propylimidazole, 1-isopropylimidazole, 1,2-dimethylimidazole, 2-ethyl-4-ethylimidazole, imidazole, 1-benzyl-2-phenylimidazole, 1-vinylimidazole, 2-methylimidazole, 2-heptadecylimidazole, 2-phenylimidazole and mixtures thereof.

15. The solid resin system according to claim 10, wherein starting materials from which said solid resin is formed contains an accelerator component selected from the group consisting of phthalic anhydride, tetrahydrophthalic anhydride, methylnadic anhydride, hydrogenated methylnadic anhydride, methylhexahydrophthalic anhydride, hexahydrophthalic anhydride, methyltetrahydrophthalic anhydride, and derivatives and mixtures thereof.

16. The solid resin system according to claim 10, wherein starting materials from which said solid resin is formed include a filler selected from the group consisting of SiO₂, dolomite, Al₂O₃, CaCO₃, TiO₂ and derivatives and mixtures thereof.

17. The solid resin system according to claim 10, wherein starting materials from which said solid resin is formed include Al₂O₃ with a d₅₀ of ≧2 μm to ≧6 μm.

18. A method of using a solid resin system formed from starting components containing a solid resin based on bisphenol A and a liquid resin based on bisphenol F, which comprises the steps of:
forming an insulating composition from the solid resin system; and
using the insulating composition in electrical switchgear.
